(19) United States
(12) Patent Application Publication
(10) Pub. No.: US 2018/0283480 A1
(43) Pub. Date: Oct. 4, 2018

(54) HIGH-MANGANESE STEEL BRAKE DISK

(71) Applicants: POSCO, Pohang-si, Gyeongsangbuk-do (KR); Research Institute of Industrial Science & Technology, Pohang-si, Gyeongsangbuk-do (KR)

(72) Inventor: Kwang-Soo PARK, Pohang-si, Gyeongsangbuk-do (KR)

(73) Assignees: POSCO, Pohang-si, Gyeongsangbuk-do (KR); Research Institute of Industrial Science & Technoogy, Pohang-si, Gyeongsangbuk-do (KR)

(21) Appl. No.: 15/778,491

(22) PCT Filed: Dec. 6, 2016
(86) PCT No.: PCT/KR2016/014239

§ 371 Date: May 23, 2018

(30) Foreign Application Priority Data
Dec. 11, 2015 (KR) 10-2015-0177304

(51) Int. Cl. F16D 65/12; C22C 38/04

(52) U.S. Cl. CPC F16D 65/125; C22C 38/20; C22C 38/04

(57) ABSTRACT

In accordance with one aspect of the present invention, there is provided a high-manganese steel brake disk comprising: a first disk member that includes a first disk main body, a plurality of first concave-convex portions arranged on the first disk main body so as to be radially spaced apart from each other, and a first insertion portion formed between the first concave-convex portions adjacent to each other; and a second disk member that includes a second disk main body, a plurality of second concave-convex portions arranged on the second disk main body so as to be radially spaced apart from each other, and a second insertion portion formed between the second concave-convex portions adjacent to each other.

### TECHNICAL FIELD

The present disclosure relates to a high-manganese steel brake disk, and more particularly, to a high-manganese steel brake disk having improved braking performance, abrasion resistance, and heat dissipation characteristics through the use of a brake disk including high manganese steel.

### BACKGROUND ART

In general, braking devices mounted in vehicles are devices for reducing the speed of moving vehicles or bringing moving vehicles to a completely stopped state. Generally, compressed oil, pressurized according to the pressure of brake pedals, or high-pressure compressed air stored in air tanks, is forcedly supplied to brake mechanisms installed on the sides of vehicle wheels, from master cylinders, such that brake drums or brake disks may respectively be braked.

Brake disks may generate a braking effect by being contacted by brake pads. In the case of braking devices according to the related art, brake disks contacted by brake pads to generate braking power are commonly manufactured using general carbon steel.

However, general carbon steel used for brake disks according to the related art has negative properties, such as being relatively heavy due to the specific gravity thereof, a major cause of reduced fuel efficiency in the case in which carbon steel brake disks are applied to vehicles, or the like.

In the case of the brake disks according to the related art formed of general carbon steel, a problem in which corrosion may occur on the braking surfaces of brake disks due to environmental conditions such as humidity, temperature, and the like, may exist.

Thus, the development of a brake disk formed of a material other than carbon steel, able to maintain excellent braking performance, heat dissipation performance, and corrosion resistance and reduce a weight of the brake disk, is required.

In the case of a brake disk according to the related art, an air vent is integrally formed therein, so the brake disk is only produced using a casting method. Moreover, the brake disk is not provided as a divided type brake disk. Thus, there may be a problem in which a brake disk is not able to be produced using a forging method, a production method used when securing of high rigidity is required.

### DISCLOSURE

### Technical Problem

The present disclosure is realized by recognizing at least one of the requirements or problems generated in a brake disk according to the related art.

An aspect of the present disclosure may provide a high-manganese steel brake disk in which excellent physical properties such as abrasion resistance and rigidity are able to be secured, by producing a brake disk using a forging method by providing a brake disk as a divided type disk member.

An aspect of the present disclosure may provide a high-manganese steel brake disk capable of improving a heat dissipation performance and improving productivity, by forming an air vent for improving a heat dissipation performance while firmly coupling a divided type disk member using a simple method, by coupling a divided type disk member using a method for inserting a protrusion portion into an insertion portion.

An aspect of the present disclosure may provide a high-manganese steel brake disk capable of improving heat dissipation characteristics, abrasion resistance, and braking performance by using a brake disk including high-manganese steel, a material with excellent thermal conductivity and abrasion resistance and a high frictional coefficient.

An aspect of the present disclosure may provide a high-manganese steel brake disk capable of improving fuel efficiency of a vehicle, or the like, by reducing the weight of the brake disk, by manufacturing the brake disk using high-manganese steel having a low specific gravity, as compared to general carbon steel.

### Technical Solution

According to an aspect of the present disclosure, a high-manganese steel brake disk includes: a first disk member including a first disk main body, a plurality of first protrusion portions disposed on the first disk main body to be radially spaced apart from each other, and a first insertion portion formed between the first protrusion portions adjacent to each other; and a second disk member including a second disk main body, a plurality of second protrusion portions disposed on the second disk main body to be radially spaced apart from each other, and a second insertion portion formed between the second protrusion portions adjacent to each other, wherein the first disk member and the second disk member are formed of high-manganese steel, and the first disk member and the second disk member are fixed to each other while the first protrusion portion is inserted into the second insertion portion, and the second protrusion portion is inserted into the first insertion portion.

A height of the first protrusion portion, protruding from the first disk main body, may be greater than a height of the second protrusion portion, protruding from the second disk main body, and the first disk member and the second disk member may be fixed to each other while an air vent, a space in which the first protrusion portion is in contact with a bottom surface of the second insertion portion, and the second protrusion portion and the first insertion portion are spaced apart from each other while opposing each other, is provided.

A fastening hole, located inwardly of a surface in which each of the first disk main body and the second disk main body is in contact with a brake pad, may be provided, and the fastening hole may be disposed in a position in which each of the first protrusion portion and the second insertion portion is formed, and may be fastened by a fastening member while the first protrusion portion is in contact with a bottom surface of the second insertion portion.

The first disk main body and the second disk main body may be provided as a plate-shaped member with a ring shape having a hollow portion formed therein, and the first protrusion portion and the second protrusion portion may be radially disposed in the plate-shaped member with a ring shape, and may be provided as a rod-shaped member having a rectangular cross section or a rod-shaped member having a rectangular cross section and having a constant curvature.

A width of the second protrusion portion may be 1.5 to 2.2 times a width of the first protrusion portion, and a width of the air vent may be 1.5 to 2.2 times the width of the first protrusion portion.

The first disk member and the second disk member may be formed of high-manganese steel, including 1.09 wt % to 1.31 wt % of carbon (C), 16 wt % to 20 wt % of manganese (Mn), and iron (Fe) and inevitable impurities as a remainder thereof.

The first disk member and the second disk member may be formed of high-manganese steel including a basic composition including 1.09 wt % to 1.31 wt % of C, 16 wt % to 20 wt % of Mn, andiron (Fe) and inevitable impurities as a remainder thereof, and including one or more selected from the group consisting of 2.2 wt % to 2.8 wt % of chromium (Cr) and 0.3 wt % to 0.7 wt % of copper (Cu) in addition to the basic composition.

The first disk member and the second disk member may be formed of high-manganese steel including 1.09 wt % to 1.31 wt % of C, 16 wt % to 20 wt % of Mn, 2.2 wt % to 2.8 wt % of Cr, 0.3 wt % to 0.7 wt % of Cu, and iron (Fe) and inevitable impurities as a remainder thereof.

### Advantageous Effects

According to an example embodiment, a divided type disk member is coupled using a method in which a protrusion portion is inserted into an insertion portion, so a divided type disk member may be firmly coupled using a simple method, and an air vent for improving a heat dissipation performance may be formed simultaneously. Thus, a heat dissipation performance may be improved, and productivity may be also improved.

According to an example embodiment, a brake disk is provided as a divided type brake disk including a first disk member and a second disk member, so a brake disk may be produced using a forging method. Thus, excellent physical properties such as abrasion resistance, rigidity, and the like, may be easily ensured.

According to an example embodiment, while the first protrusion portion is inserted into the second insertion portion, and the second protrusion portion is inserted into the first insertion portion, the first disk member and the second disk member are fixed to each other. Thus, a divided type disk member is coupled using a method in which a protrusion portion is inserted into an insertion portion, so a divided type disk member may be firmly coupled using a simple method.

According to an example embodiment, disk members may be fixed to each other while an air vent, a space, in which a first protrusion portion is in contact with a bottom surface of a second insertion portion, and the second protrusion portion and the first insertion portion are spaced apart from each other while opposing each other, is provided. Thus, a divided type disk member may be firmly coupled using a simple method, while an air vent for improving a heat dissipation performance may be formed. Thus, a heat dissipation performance may be improved, and productivity may be also improved.

According to an example embodiment, a width of a second protrusion portion is provided to be greater than a width of a first protrusion portion, so a width of an air vent may be formed to be greater than the width of the first protrusion portion. Thus, an air vent is formed to be large, a heat dissipation performance of a brake disk may be improved. Furthermore, as an air vent is formed to be large, the weight of a brake disk may be reduced.

According to an example embodiment, a first disk member and a second disk member include high-manganese steel, a material having excellent thermal conductivity and abrasion resistance and having a high frictional coefficient, so heat dissipation characteristics, abrasion resistance, and a braking performance of a brake disk may be improved.

According to an example embodiment, a brake disk is provided as a divided type, in which a first disk member and a second disk member are divided, and a method in which the disk members are fastened by a fastening member is adopted. Thus, production may be possible not using a casting method according to the related art but a forging method. Moreover, a brake disk in which the forging method is adopted and material characteristics of high-manganese steel are used may be produced, so excellent physical properties, such as a reduction in weight of a brake disk, improved abrasion resistance, improved braking performance, and the like, may be easily secured.

According to an example embodiment, a brake disk is manufactured using high-manganese steel having a low specific gravity, as compared to general carbon steel, so the weight of a brake disk may be reduced and fuel consumption of a vehicle, and the like, may be improved.

### DESCRIPTION OF DRAWINGS

FIG. 1 is an exploded perspective view of a high-manganese steel brake disk according to an example embodiment.

FIG. 2 is a perspective view illustrating a coupled state of the brake disk illustrated in FIG. 1.

FIG. 3A is a cross-sectional view illustrating the brake disk taken along line A-A′ of FIG. 2.

FIG. 3B is a cross-sectional view illustrating the brake disk taken along line B-B′ of FIG. 2.

FIG. 4 is an exploded perspective view of a high-manganese steel brake disk according to another example embodiment.

FIG. 5 is a perspective view illustrating a coupled state of the brake disk illustrated in FIG. 4.

FIG. 6A is a cross-sectional view illustrating the brake disk taken along line C-C′ of FIG. 5.

FIG. 6B is a cross-sectional view illustrating the brake disk taken along line D-D′ of FIG. 5.

FIG. 7 is a drawing illustrating a change in frictional coefficient according to a distance and a change in thermal conductivity according to a temperature, between high-manganese steel applied to an example embodiment and general carbon steel.

FIG. 8 is a drawing illustrating evaluation results of a performance test of a brake disk between Sample 1 (CASE 1), and Sample 2 (CASE 2) according to an example embodiment by Korea Automotive Technology Institute.

FIGS. 9A and 9B are drawings illustrating a reference picture in a performance test of a high-manganese steel brake disk according to the present disclosure in the Korea Automotive Technology Institute by applying Sample 2 (CASE 2).

### BEST MODE FOR INVENTION

Hereinafter, embodiments of the present disclosure will be described with reference to the attached drawings. However, the embodiments of the present disclosure can be modified into various other forms, and the scope of the present disclosure is not limited to the embodiments described below. Further, the embodiments of the present disclosure are provided to more fully explain the present disclosure to those skilled in the art. The shape and size of the elements in the drawings may be exaggerated for clarity.

Hereinafter, a high-manganese steel brake disk according to an embodiment of the present disclosure will be described in detail with reference to the drawings.

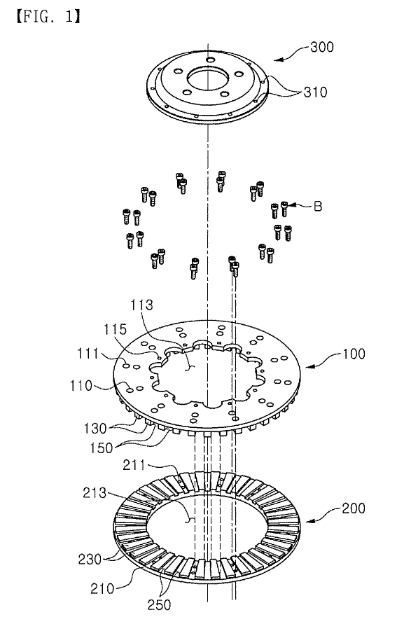

Referring to FIG. 1, a high-manganese steel brake disk according to an example embodiment includes a first disk member 100 and a second disk member 200, and additionally includes a shaft coupling portion 300.

As illustrated in FIG. 1, a high-manganese steel brake disk may include the first disk member 100, including a first disk main body 110, a plurality of first protrusion portions 130, arranged on the first disk main body 110 to be radially spaced apart from each other, and a first protrusion portion 130 formed between the first protrusion portions 130 adjacent to each other, as well as the second disk member 200, including a second disk main body 210, a plurality of second protrusion portions 230, arranged on the second disk main body 210 to be radially spaced apart from each other, and a second insertion portion 250 formed between the second protrusion portions 230 adjacent to each other.

The first disk member 100 and the second disk member 200 may be formed of high-manganese steel.

In this case, while the first protrusion portions 130 are inserted into the second insertion portion 250, and the second protrusion portions 230 are inserted into the first protrusion portions 130, the first disk member 100 and the second disk member 200 may be fixed to each other.

The first disk member 100 may include the first disk main body 110, a plurality of first protrusion portions 130, and the first protrusion portions 130.

As illustrated in FIG. 1, the first protrusion portions 130 are provided in a space surrounded by the first disk main body 110, and a side surface of the first protrusion portions 130 disposed adjacent to both side surfaces of the first disk main body 110.

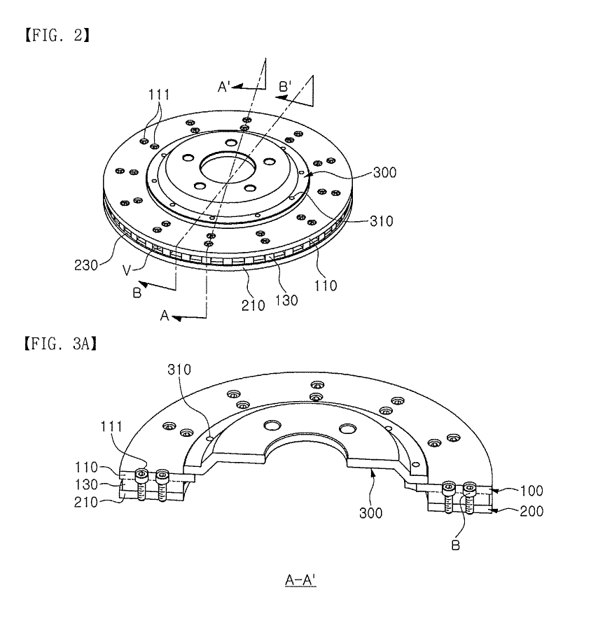

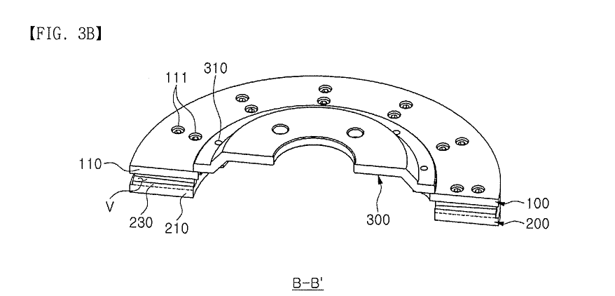

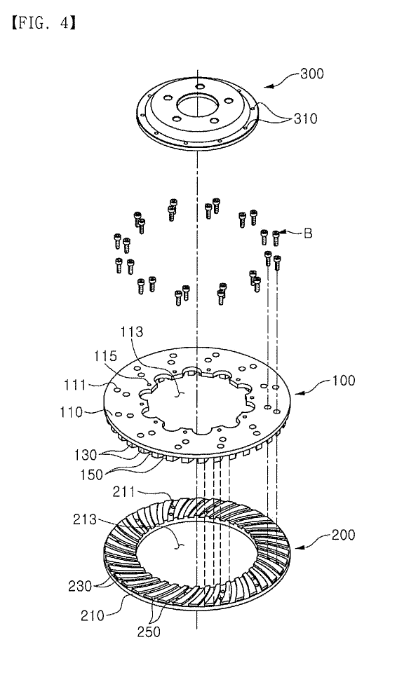

As illustrated in FIGS. 2 and 3B, when the first disk member 100 and the second disk member 200 are coupled, the second protrusion portions 230 may be inserted into the first protrusion portions 130, and a height of the first protrusion portions 130 may be provided to be greater than a height of the second protrusion portions 230.

In this case, while the first disk member 100 and the second disk member 200 are coupled, an air vent V, in a form communicated in a horizontal direction, may be formed in a portion of the first protrusion portions 130 into which the second protrusion portions 230 is inserted.

The second disk member 200 may include the second disk main body 210, a plurality of second protrusion portions 230, and the second insertion portion 250.

As illustrated in FIG. 1, the second insertion portion 250 is a space surrounded by the second disk main body 210, and a side surface of the second protrusion portions 230 disposed adjacent to both side surfaces of the second disk main body 210.

As illustrated in FIGS. 2 and 3A, the first protrusion portions 130 may be inserted into the second insertion portion 250, a height of the second insertion portion 250 may be formed to be lower than a height of the first protrusion portions 130, and the first protrusion portions 130 may be coupled to the first disk member 100 and the second disk member 200 while being in contact with a bottom surface of the second insertion portion 250.

As illustrated in FIG. 1, the first protrusion portions 130 are radially disposed around the center of the first disk main body 110, and the second protrusion portions 230 are radially disposed around the second disk main body 210.

As illustrated in FIG. 3A, the second protrusion portion 230 is inserted into the first insertion portion 150, the first protrusion portions 130 is inserted into the second insertion portion 230, and a fastening member B may be fastened to a position in which the first protrusion portions 130 and the second insertion portion 250 are coupled to each other.

While the second protrusion portions 230 is inserted into the first protrusion portions 130, and the first protrusion portions 130 is inserted into the second insertion portion 250, protruding side surfaces of the first protrusion portions 130 and the second protrusion portions 230 may be formed to be contact with each other.

While the second protrusion portions 230 is inserted into the first protrusion portions 130, and the first protrusion portions 130 is inserted into the second insertion portion 250, torque may be supported in a rotational direction of a disk, and the first disk member 100 and the second disk member 200 may be fastened by the fastening member B to be stacked.

As described above, to couple the first disk member 100 to the second disk member 200, a method for coupling disk members to be stacked is applied. Thus, while torque in a rotational direction of a brake disk, which is difficult to be supported only by fastening of the fastening member B, such as a bolt member, or the like, is stably supported, the first disk member 100 and the second disk member 200 may be stably fastened.

The shaft coupling portion 300, coupled to a disk main body and coupled to a rotational shaft of a wheel, may be formed in a brake disk, and a plurality of coupling holes 310 for coupling a disk main body may be radially disposed in the shaft coupling portion 300.

A plurality of coupling holes 115, formed in a position corresponding to the coupling holes 310 formed in the shaft coupling portion 300, may be formed in a disk main body, and the disk main body and the shaft coupling portion 300 may be fixed to each other by fastening the coupling holes 310 and 115, formed in the shaft coupling portion 300 and a first disk main body 310, with a fastening member such as a bolt (not shown), or the like.

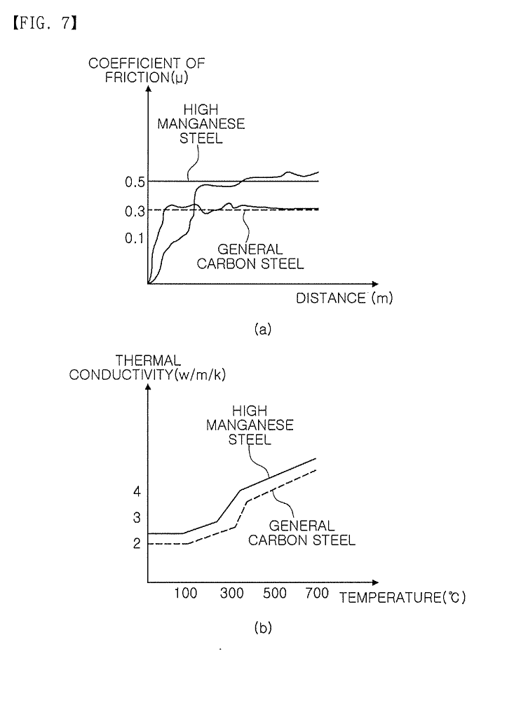

As illustrated in FIGS. 2, 3A, 5, and 6A, a height of the first protrusion portions 130, protruding from the first disk main body 110, is formed to be greater than a height of the second protrusion portions 230, protruding from the second disk main body 210, and the first disk member 100 and the second disk member 200 may be fixed to each other while the air vent V, a space in which the first protrusion portion 130 is in contact with a bottom surface of the second insertion portion 250, and the second protrusion portions 230 and the first protrusion portions 130 are spaced apart from each other while opposing each other, is provided.

As illustrated in FIGS. 1 to 3B, a configuration, in which the first disk member 100 and the second disk member 200 are fixed to each other in a case in which the first protrusion portions 130 is inserted into the second insertion portion 250, and the second protrusion portions 230 is inserted into the first protrusion portions 130, is included. Thus, a divided type disk member is coupled using a method in which a protrusion portion is inserted into an insertion portion, so the divided type disk member may be firmly coupled using a simple method.

The configuration, in which disk members are fixed to each other while an air vent V is provided, is included. In this case, the air vent is a space, in which the first protrusion portions 130 and a bottom surface of the second insertion portion 250 are in contact with each other, and the second protrusion portions 230 and the first protrusion portions 130 are spaced apart from each other while opposing each other. Thus, a divided type disk member is firmly coupled using a simple method, and the air vent V for improving heat dissipation performance is formed simultaneously, so productivity may be improved while a heat dissipation performance may be also improved.

A height of the first protrusion portions 130, protruding from the first disk main body 110, may be 2 to 2.8 times a height of the second protrusion portions 230, protruding from the second disk main body 210. Thus, a height of the air vent V may be formed to be 1 to 1.8 times a height of the second protrusion portions 230, so a heat dissipation performance may be optimized while a coupling force of a high-manganese steel brake disk is prevented from being reduced.

The result described above is an optimum value derived to obtain an excellent heat dissipation performance within a range in which a significant reduction in a coupling force of a high-manganese steel brake disk does not occur, as a result of repeatedly conducting a test by setting a height of the first protrusion portions 130, protruding from the first disk main body 110, and a height of the second protrusion portions 230, protruding from the second disk main body 210, to various values.

If the height of the first protrusion portions 130, protruding from the first disk main body 110, is less than or equal to two times the height of the second protrusion portions 230, protruding from the second disk main body 210, a size of the air vent V is significantly reduced, so a heat dissipation performance of a high-manganese steel brake disk may be significantly reduced.

Moreover, if the height of the first protrusion portions 130, protruding from the first disk main body 110, is 2.8 times or greater than the height of the second protrusion portions 230, protruding from the second disk main body 210, a problem in coupling force of a high-manganese steel brake disk may occur.

As illustrated in FIG. 3A, a fastening hole, formed to be located inwardly of a surface in which each of the first disk main body 110 and the second disk main body 210 is in contact with a brake pad, is provided. Moreover, the fastening hole is disposed in a position, in which the first protrusion portions 130 and the second insertion portion 250 are formed, and thus is fastened by the fastening member B while being in contact with the first protrusion portions 130 and a bottom surface of the second insertion portion 250.

The fastening hole is a hole in which the fastening member B is installed for coupling the first disk member 100 and the second disk member 200, and may be installed to be located inwardly of a surface in which each of the first disk main body 110 and the second disk main body 210 is in contact with a brake pad.

In other words, when the fastening member B, such as a bolt member, or the like, is inserted into a fastening hole to be fastened, a head portion of the bolt member may be fastened to be located further inward, as compared to a contact surface in which each of the first disk main body 110 and the second disk main body 210 is in contact with a brake pad.

In this case, the fastening hole preferably includes a protrusion portion having a diameter corresponding to a diameter of a head portion of the fastening member B, and a through portion with a portion having a diameter corresponding to a diameter of a body portion in which a thread of the fastening member B is formed.

In this case, when the fastening member B is fastened to a fastening hole, to allow the fastening member B to be located inwardly of a disk main body, a height of the protrusion portion may be formed to be greater than a height of the head portion of the fastening member B.

The fastening hole may be formed using a separate fastening hole forming process in a state in which the first disk member 100 and the second disk member 200 have been manufactured using a forging method, and the fastening hole may be formed to have an inner diameter having a size corresponding to that of an outer diameter of a body portion in which a thread of the fastening member B is formed.

As illustrated in FIGS. 1 and 3A, fastening holes, formed in the first disk main body 110 and the second disk main body 210, may be disposed to be spaced apart from each other at predetermined intervals in a radial form based on the center of a disk main body. Moreover, when the first disk member 100 and the second disk member 200 overlap and are coupled to each other, a first fastening hole 111, formed in the first disk main body 110, and a second fastening hole 211, formed in the second disk main body 210, may be disposed in positions opposing each other.

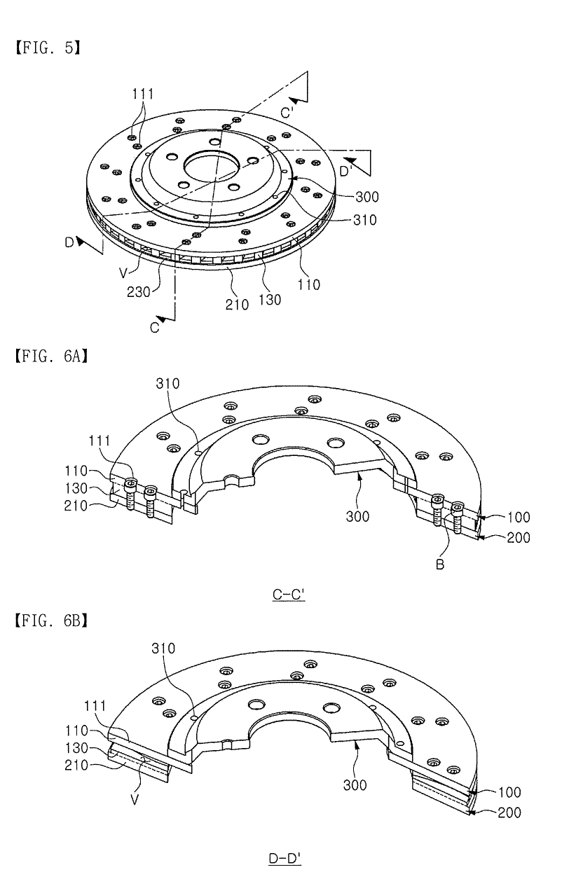

As illustrated in FIGS. 1 and 5, the first disk main body 110 the second disk main body 210 are provided as a plate-shaped member with a ring shape having hollow portions 113 and 213 formed therein, while the first protrusion portions 130 and the second protrusion portions 230 may be radially disposed on the plate-shaped member with a ring shape.

In this case, as illustrated in FIG. 1, the first protrusion portions 130 and the second protrusion portions 230 may be provided as a rod-shaped member having a rectangular cross section. In this case, the air vent V formed by coupling the first disk member 100 and the second disk member 200 may have a linear air flow path having a rectangular cross section.

As illustrated in FIG. 5, the first protrusion portions 130 and the second protrusion portions 230 may be provided as a rod-shaped member having a rectangular cross section and having a constant curvature. In this case, the air vent V, formed by coupling the first disk member 100 and the second disk member 200, has a rectangular cross section, and a curved air flow path in the form of being bent at a constant curvature may be formed.

A width of the second protrusion portion 230 is provided to be greater than a width of the first protrusion portion 130, so a width of the air vent V may be formed to be greater than the width of the first protrusion portion 130.

The widths of the first protrusion portions 130 and the second protrusion portions 230 may be the same. However, preferably, the width of the second protrusion portion 230 is provided to be greater than the width of the first protrusion portion 130, so the width of the air vent V may be formed to be greater than the width of the first protrusion portion 130.

The air vent V is formed to be large, so a heat dissipation performance of a high-manganese steel brake disk is improved. Furthermore, as the air vent V is formed to be large, a weight of a high manganese steel brake disk may be reduced.

As described above, as a high-manganese steel brake disk is lightweight, the amount of high-manganese steel used in the manufacturing of a brake disk is reduced as by much as a space of the air vent V, formed to be large, so production costs may be reduced, and fuel consumption of a vehicle, or the like, may be reduced.

Moreover, through the air vent V, formed to be large, flow of air is improved, so heat dissipation characteristics of a brake disk may be improved.

A width of the second protrusion portion 230 is provided to be 1.5 to 2.2 times a width of the first protrusion portion 130, so a width of the air vent V may be provided to be 1.5 to 2.2 times the width of the first protrusion portion 130. In this case, while a reduction of a coupling force of a brake disk is prevented, a heat dissipation performance may be optimized.

The result described above is an optimum value derived to obtain an excellent heat dissipation performance within a range in which a significant reduction in a coupling force of a high-manganese steel brake disk does not occur, as a result of repeatedly conducting a test by setting a width of the second protrusion portion 230 and a width of the first protrusion portion 130, to various values.

If the width of the second protrusion portion 230 is greater than or equal to 2.2 times the width of the first protrusion portion 130, a problem in a coupling force of a brake disk may occur.

The first disk member 100 and the second disk member 200 may be formed of high-manganese steel.

When the first disk member 100 and the second disk member 200 are formed of high-manganese steel, heat dissipation characteristics, abrasion resistance, and a braking performance of a brake disk may be improved.

In detail, the first disk main body 110 and the second disk main body 210, in contact with a brake pad, include a high-manganese steel with a high frictional coefficient (unit: proportional constant μ), thereby improving abrasion resistance and braking performance. Moreover, the first protrusion portions 130 and the second protrusion portions 230, forming the air vent V, include high-manganese steel, thereby improving heat dissipation characteristics.

Although not illustrated, as another embodiment, the entirety of the first disk member 100 and the second disk member 200 does not include high-manganese steel, but at least the first disk main body 110 and the second disk main body 210, of the first disk member 100 and the second disk member 200, in contact with brake pad, may be formed of high-manganese steel.

When a brake disk is manufactured using high-manganese steel, there is a problem in which castability of high-manganese steel is reduced, so it may be difficult to manufacture a brake disk including a material of high-manganese steel using a casting method, used when a brake disk is manufactured using general carbon steel, according to the related art.

Thus, a high-manganese steel brake disk is provided as a divided type brake disk in which the first disk member 100 and the second disk member 200 are divided from each other, and a method of fastening the disk members by the fastening member B is adopted. Thus, a brake disk, which can be produced using not a casting method according to the related art but a forging method, and in which a forging method is adopted and material characteristics of high-manganese steel are used, may be produced. Thus, effects of securing excellent physical properties such as the reduced weight of a brake disk, improved abrasion resistance, improved braking performance, and the like, may be provided.

The first disk member 100 and the second disk member 200, according to the present disclosure, may be manufactured using high-manganese steel including 1.09 wt % to 1.31 wt % of carbon (C), 16 wt % to 20 wt % of manganese (Mn), and iron (Fe) and inevitable impurities as a remainder thereof.

FIG. 7A is a graph illustrating changes in frictional coefficient according to a distance between high-manganese steel including 1.09 wt % to 1.31 wt % of C, 16 wt % to 20 wt % of Mn, and Fe and inevitable impurities as a remainder thereof according to an embodiment, and general carbon steel.

FIG. 7B is a graph illustrating changes in thermal conductivity according to a temperature between high-manganese steel including 1.09 wt % to 1.31 wt % of C, 16 wt % to 20 wt % of Mn, and iron (Fe) and inevitable impurities as a remainder thereof according to an embodiment, and general carbon steel.

The first disk member 100 and the second disk member 200 are manufactured using high-manganese steel including 1.09 wt % to 1.31 wt % of C, 16 wt % to 20 wt % of Mn, and Fe and inevitable impurities as a remainder thereof, and general carbon steel, and a braking performance, abrasion resistance, and a heat dissipation performance are compared to each other. It could be appreciated from the comparison results that in the case in which the first disk member 100 and the second disk member 200 have been formed using high-manganese steel including 1.09 wt % to 1.31 wt % of C, 16 wt % to 20 wt % of Mn, and Fe and inevitable impurities as a remainder thereof, a braking performance, abrasion resistance, and a heat dissipation performance have been significantly improved, as compared to the case in which the first disk member 100 and the second disk member 200 are formed using general carbon steel.

In addition, the first disk member 100 and the second disk member 200 may be formed to include a basic composition including 1.09 wt % to 1.31 wt % of C, 16 wt % to 20 wt % of Mn, and iron (Fe) and inevitable impurities as a remainder thereof and to include one or more selected from the group consisting of 2.2 wt % to 2.8 wt % of chromium (Cr) and 0.3 wt % to 0.7 wt % of copper (Cu) in addition to the basic composition.

Further, the first disk member 100 and the second disk member 200 may be formed of high-manganese steel, including 1.09 wt % to 1.31 wt % of C, 16 wt % to 20 wt % of Mn, 2.2 wt % to 2.8 wt % of Cr, 0.3 wt % to 0.7 wt % of Cu, and Fe and inevitable impurities as a remainder thereof.

When the first disk member 100 and the second disk members 200 are manufactured in a composition ratio as described above, it could be seen that a braking performance of a brake is improved by 15% or more.

The performance test results are described in detail in the High-Manganese Steel Brake Disk Test Report (Korea Automotive Technology Institute, Test Report No.: KTS 153152-2).

In the following, performance test results of brake disk sample 1 (CASE 1) and brake disk sample 2 (CASE 2) will be compared with reference to the following high-manganese steel brake disk test report (Korea Automotive Technology Institute, Test Report Number: KTS 153152-2).

Sample 1 (CASE 1): Grandeur TG brake disk (TG OEM Disk) formed of general carbon steel

Sample 2 (CASE 2): High-manganese steel brake disk in which the first disk member 100 and the second disk members 200 are formed of 1.09 wt % to 1.31 wt % of C, 16 wt % to 20 wt % of Mn, 2.2 wt % to 2.8 wt % of Cr, 0.3 wt % to 0.7 wt % of Cu, and Fe and inevitable impurities as a remainder thereof.

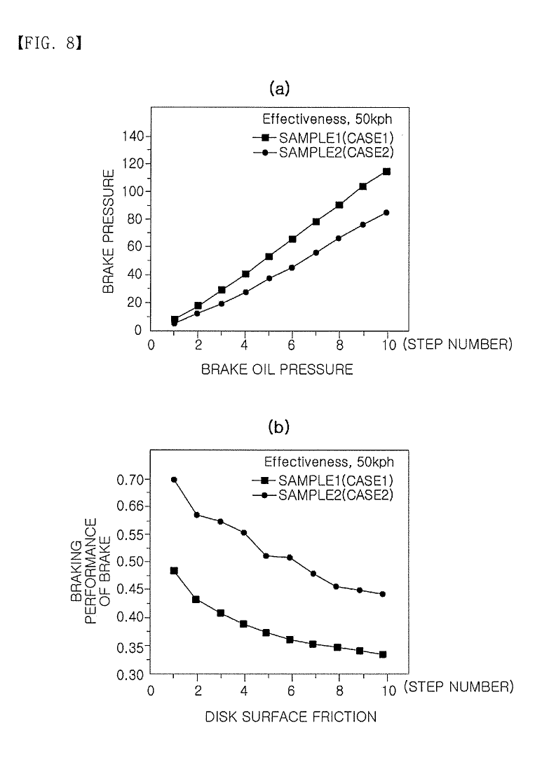

FIG. 8 is a drawing illustrating evaluation results of a performance test (Certification No: KTS 153152-2) of a brake disk between Sample 1 (CASE 1), and Sample 2 (CASE 2) according to an example embodiment by the Korea Automotive Technology Institute.

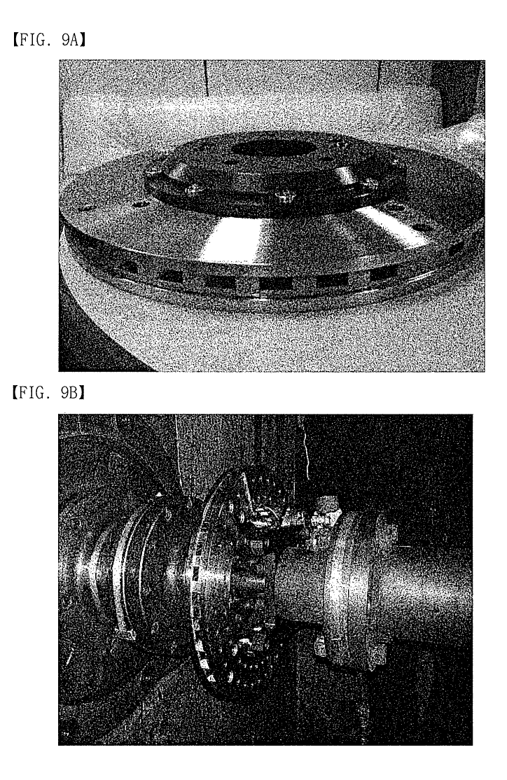

FIGS. 9A and 9B are drawings illustrating a reference picture in a performance test of a high-manganese steel brake disk according to the present disclosure in Korea Automotive Technology Institute by applying Sample 2 (CASE 2).

Referring to FIG. 8A, a brake oil pressure of the case of Sample 2 (CASE 2) is lower than that of Sample 1 (CASE 1) by about 10% to about 15%.

In other words, relatively low brake oil pressure in Sample 2 may indicate that pressure of the brake of Sample 2 (CASE 2) to be exerted for the same degree of braking when a vehicle is braked by stepping on the brake is less than that of Sample 1 (CASE 1).

Thus, in the case of Sample 2 (CASE 2), it can be appreciated that a braking performance of a brake disk is improved because sufficient braking is possible even when pressing on a brake lever with relatively low force, as compared with that of Sample 1 (CASE 1).

Referring to FIG. 8B, it can be seen that a disk surface friction of Sample 2 (CASE 2) is about 1.5 to 2 times a disk surface friction of Sample 1 (CASE 1).

In other words, it can be appreciated that disk surface friction in Sample 2 (CASE 2) is significantly increased and a braking performance of a brake is significantly improved, as compared to Sample 1 (CASE 1).

Referring to the results of FIGS. 8A and 8B and the test report of the high-manganese steel brake disk (Korea Automotive Technology Institute, Test Report No. KTS 153152-2), it can be seen that as a result of comparing the braking performance of the brake disks of Sample 2 (CASE 2) and Sample 1 (CASE 1), Sample 2 has braking performance of the brake having been improved by 15% or more, as compared with Sample 1 (CASE 1).

While exemplary embodiments have been shown and described above, it will be apparent to those skilled in the art that modifications and variations could be made without departing from the scope of the present invention as defined by the appended claims.

1. A high-manganese steel brake disk, comprising:
a first disk member including a first disk main body, a plurality of first protrusion portions disposed on the first disk main body to be radially spaced apart from each other, and a first insertion portion formed between the first protrusion portions adjacent to each other; and
a second disk member including a second disk main body, a plurality of second protrusion portions disposed on the second disk main body to be radially spaced apart from each other, and a second insertion portion formed between the second protrusion portions adjacent to each other,
wherein the first disk member and the second disk member are formed of high-manganese steel, and
the first disk member and the second disk member are fixed to each other while the first protrusion portion is inserted into the second insertion portion, and the second protrusion portion is inserted into the first insertion portion.

2. The high-manganese steel brake disk of claim 1, wherein a height of the first protrusion portion, protruding from the first disk main body, is greater than a height of the second protrusion portion, protruding from the second disk main body, and
the first disk member and the second disk member are fixed to each other while an air vent, a space in which the first protrusion portion is in contact with a bottom surface of the second insertion portion, and the second protrusion portion and the first insertion portion are spaced apart from each other while opposing each other, is provided.

3. The high-manganese steel brake disk of claim 1, wherein a fastening hole, located inwardly of a surface in which each of the first disk main body and the second disk main body is in contact with a brake pad, is provided, and
the fastening hole is disposed in a position in which each of the first protrusion portion and the second insertion portion is formed, and is fastened by a fastening member while the first protrusion portion is in contact with a bottom surface of the second insertion portion.

4. The high-manganese steel brake disk of claim 1, wherein the first disk main body and the second disk main body are provided as a plate-shaped member with a ring shape having a hollow portion formed therein, and
the first protrusion portion and the second protrusion portion are radially disposed in the plate-shaped member with a ring shape, and are provided as a rod-shaped member having a rectangular cross section or a rod-shaped member having a rectangular cross section and having a constant curvature.

5. The high-manganese steel brake disk of claim 2, wherein a width of the second protrusion portion is 1.5 to 2.2 times a width of the first protrusion portion, and
a width of the air vent is 1.5 to 2.2 times the width of the first protrusion portion.

6. The high-manganese steel brake disk of claim 1, wherein the first disk member and the second disk member are formed of high-manganese steel, including 1.09 wt % to 1.31 wt % of carbon (C), 16 wt % to 20 wt % of manganese (Mn), and iron (Fe) and inevitable impurities as a remainder thereof.

7. The high-manganese steel brake disk of claim 1, wherein the first disk member and the second disk member are formed of high-manganese steel including a basic composition including 1.09 wt % to 1.31 wt % of C, 16 wt % to 20 wt % of Mn, and iron (Fe) and inevitable impurities as a remainder thereof, and
including one or more selected from the group consisting of 2.2 wt % to 2.8 wt % of chromium (Cr) and 0.3 wt % to 0.7 wt % of copper (Cu) in addition to the basic composition.

8. The high-manganese steel brake disk of claim 2, wherein the first disk member and the second disk member are formed of high-manganese steel, including 1.09 wt % to 1.31 wt % of C, 16 wt % to 20 wt % of Mn, 2.2 wt % to 2.8 wt % of Cr, 0.3 wt % to 0.7 wt % of Cu, and iron (Fe) and inevitable impurities as a remainder thereof.
